(19) United States
(12) Patent Application Publication
(10) Pub. No.: US 2007/0124944 A1
(43) Pub. Date: Jun. 7, 2007

(54) Razor blade and method of making it

(75) Inventors: Jochen Thoene, Wuppertal (DE); Matthias Niggemann, Wuppertal (DE)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/605,775

(22) Filed: Nov. 27, 2006

Related U.S. Application Data
(60) Provisional application No. 60/741,144, filed on Nov. 30, 2005.

(51) Int. Cl. B26B 21/54

(52) U.S. Cl. 30/346.54

(57) ABSTRACT

Compositions that are useful in imparting lubricity to the cutting edge of razor blades, razor blades provided with an improved outer coating layer on the sharpened tip, a method of making said improved razor blade and a shaving razor comprising said improved razor blade are disclosed.

### CROSS-REFERENCE TO RELATED APPLICATION

This application claims the benefit of U.S. provisional patent application Ser. No. 60/741,144 filed Nov. 30, 2005, which is hereby incorporated herein in its entirety.

### TECHNICAL FIELD

The present invention relates to compositions that are useful in imparting lubricity to the cutting edge of razor blades, razor blades provided with an improved outer coating layer on the sharpened tip, a method of making said improved razor blade and a shaving razor comprising said improved razor blade.

### BACKGROUND

Razor blades are typically formed of a suitable substrate material such as stainless steel, and a cutting edge is formed with a wedge-shaped configuration with an ultimate tip having a radius less than about 100 nm, such as about 20 to 30 nm. Hard coatings such as diamond, amorphous diamond, diamond-like carbon (DLC) material, nitrides, carbides, oxides or ceramics are often used to improve strength, corrosion resistance and shaving ability, maintaining needed strength while permitting thinner edges with lower cutting forces to be used. It is known that a polytetrafluoroethylene (PTFE) outer layer can be used to provide friction reduction. Interlayers of niobium or chromium containing materials can aid in improving the binding between the substrate, typically stainless steel, and hard carbon coatings, such as DLC. Examples of razor blade cutting edge structures and processes of manufacture are described in U.S. Pat. Nos. 5,295,305; 5,232,568; 4,933,058; 5,032,243; 5,497,550; 5,940,975; 5,669,144; EP 0591334; and WO 92/03330, which are hereby incorporated by reference.

It is known from the art, for instance, from U.S. Pat. Nos. 3,743,551, 3,838,512, as well as European published patent applications EP 0884142 and 0952904 that the shaving properties of a razor blade can be improved by applying a polytetrafluoroethylene coating as the upper coating.

Both U.S. published patent applications Nos. 2003/0009606 and 2003/0121158 disclose a razor blade including a substrate with a cutting edge defined by a sharpened tip and adjacent facets, a layer of hard coating on the cutting edge, an overcoat layer of a chromium containing material on the layer of hard carbon coating, and an outer layer of polytetrafluoroethylene coating over the overcoat layer. Also disclosed is a method of making a razor blade including providing a substrate with a cutting edge defined by a sharpened tip and adjacent facets, and applying an aqueous solution including polytetrafluoroethylene coating over the sharpened tip to result in an outer layer, the polytetrafluoroethylene having a molecular weight of about 45,000. The outer layer is formed from an aqueous dispersion of polytetrafluoroethylene available under the trade name Krytox® LW-1200.

U.S. Pat. No. 6,684,513, corresponding to European patent application EP 1259361, discloses a razor blade including a substrate with a cutting edge defined by a sharpened tip and adjacent facets, a layer of hard coating on the cutting edge, an overcoat layer of a chromium containing material on the layer of hard carbon coating, and an outer layer of polytetrafluoroethylene coating over the overcoat layer. The outer layer is formed from an aqueous dispersion of polytetrafluoroethylene based on Krytox® LW-1200.

U.S. Pat. No. 5,985,459 discloses to treat conventional razor blade cutting edges having an adherent polyfluorocarbon coating with a solvent to partially remove some of the coating in order to reduce the initial cutting forces of the first shave. Preferred solvents include perfluoroalkanes, perfluorocycloalkanes, perfluoropolyethers having a critical temperature or boiling point above the dissolution temperature for the polyfluorocarbon in the solvent.

WO 2005/070627 discloses a method of treating razors blade cutting edges having an adherent polyfluorocarbon coated thereon. The coated razor blade edges are treated with a solvent, which partially removes the coating from the razor blade edge. Addition of an antioxidant to the solvent improves the effectiveness of the treatment.

U.S. Pat. No. 5,263,256 discloses a method of forming a polyfluorocarbon coating on a razor blade cutting edge comprising the steps of subjecting a fluorocarbon polymer having a molecular weight of at least about 1,000,000 to ionizing radiation to reduce the average molecular weight to from about 700 to about 700,000; dispersing the irradiated fluorocarbon polymer in an aqueous solution; coating said razor blade cutting edge with the dispersion; and heating the coating obtained to melt, partially melt or sinter the fluorocarbon polymer.

GB 1,251,814 discloses that polymers such as PTFE may also be sputtered to a thickness of 20 to 200 nm either on the uncoated edge or on the metal coated edge of a razor blade.

Aqueous systems used for the formation of the outer polyfluorocarbon layer necessitate high temperatures for evaporating the water. Additionally, due to the behavior of water when it comes into contact with hot surfaces the polyfluorocarbon coating formed is not that uniform in its surface topography and thickness. Moreover, due to the water corrosion of the blades has occasionally been observed.

### BRIEF DESCRIPTION OF THE FIGURES

FIG. 1 shows a cutting edge of a razor blade coated with an alcoholic suspension of 1% by weight of PTFE according to the invention. Following the processing conditions of the invention the razor blade has been target sintered. The picture shows a continuous and closed PTFE layer of nominal thickness and width, covering the final hone and about half of the first hone angle of the razor blade facet up to a distance of about 100 μm away from the very tip.

FIG. 2 shows a cutting edge of a razor blade coated with an alcoholic suspension of 2% by weight of PTFE according to the invention. The picture shows an acceptable coating layer on the razor blade edge. In particular, the picture shows a continuous and closed PTFE layer of thickness and width at the lower specification limit, covering the final hone and about half of the first hone angle of the razor blade facet up to a distance of about 50 μm away from the tip.

FIG. 3 shows a cutting edge of a razor blade coated with an alcoholic suspension of 4% by weight of PTFE according to the invention. The picture shows a razor blade edge having an acceptable coating layer. In particular the picture shows a continuous and closed PTFE layer of thickness and width at the upper specification limit, covering the final hone and about ⅔ of the first hone angle of the razor blade facet up to a distance of about 120 μm away from the tip.

FIG. 4 shows a cutting edge of a razor blade obtained by coating with an aqueous suspension of 1% by weight of PTFE for the purpose of comparison. The razor blade edge was generated by spraying aqueous Krytox® LW-1200. The picture shows a discontinuous PTFE layer with voids and incomplete coverage of the areas of the final and first hone and, additionally, the tendency to form enriched areas of PTFE coverage in the region of the rough grinding wheels, about 200 μm away from the blade edge. This area is irrelevant for shaving and a PTFE coverage there is not desired.

All pictures were taken at a magnification of 200×.

### SUMMARY OF THE INVENTION

It has been an object of the present invention to provide a composition to be applied to the sharpened tip of the razor blade substrate for forming a thin perfluorocarbon outer coating such as a PTFE coating. Solvents contained in said composition should be highly volatile leaving behind a uniform coating after the evaporation of the solvent(s). The composition should be stable and, preferably, sprayable. Furthermore it was most desirable that the composition can be used in existing processing equipment without the necessity of making any modifications or changes. The composition should not have any adverse impact on the razor blade to be treated such as, for instance, corrosion.

It has been a further object of the present invention to provide a method of making a razor blade comprising forming an outer perfluorocarbon layer, such as a PTFE layer, to the sharpened tip of the razor blade substrate said method involving applying said outer coating layer forming composition to said sharpened tip of the razor blade substrate followed by a subsequent drying and/or sintering step.

A still further object has been the provision of a razor blade that is improved in cutting forces and lubricity and that is obtainable by the method of this invention.

Finally, it has been an object of the present invention to provide a shaving razor comprising the improved razor blade according to the invention.

The details of these and further embodiments of the invention are set forth in the description below. Other features, objects, and advantages of the invention will be apparent from the description and the claims.

### DETAILED DESCRIPTION OF THE INVENTION

The present invention relates to a composition comprising (i) a perfluoropolyalkylene compound, and (ii) an organic liquid medium having a boiling point (at an atmospheric pressure of 1013 mbar=760 torr) of about 100° C. or less. The organic medium is a liquid at room temperature (20° C.). Preferably, the boiling point of said organic liquid is about 80° C. or less. A preferred lowest boiling point of said organic medium is about 40° C. It is further preferred that the organic medium is compatible with water in that if said water is mixed at room temperature with said organic medium in an amount of up to 20% by weight, based on the mixture of water with the organic medium no distinct two phases are formed. Preferred organic media are selected from the group consisting of lower (monohydric) alcohols, lower aldehydes or lower ketones, and mixtures thereof. Preferred examples are represented by C₂-C₄ aldehydes, C₃-C₄ ketones, C₁-C₃ alcohols, sec.-butanol and tert.-butanol, and mixtures thereof. In particular preferred are solvents such as acetaldehyde, propionaldehyde, butane aldehyde, acetone, methylethyl ketone, methanol, ethanol, propanol, iso-propanol, sec.-butanol and tert.-butanol, and mixtures thereof. Particular examples of solvent mixtures are mixtures of methanol or ethanol with iso-propanol. In one embodiment of this invention the organic medium comprises an alcohol mixture of ethanol and iso-propanol which mixture contains about 10 to about 95% by weight, preferably about 30 to about 90% by weight, most preferably about 60% or 70% to about 90% by weight of ethanol, based on said alcohol mixture. Preferably, the composition of the invention is typically in the form of a suspension. For the purpose of describing this invention the terms suspension and dispersion are intended to denote the same, i.e., a system in which very small particles are uniformly dispersed in a liquid medium.

The perfluoropolyalkylene (also called perfluorocarbon) that is present in the composition of the invention is preferably selected from the group of perfluoro poly(C₂-C₄)alkylenes. Exemplary embodiments of said perfluoropolyalkylenes are represented by polytetrafluoroethylene (also known as poly(ethylene tetrafluoride), tetrafluoroethylene polymer, tetrafluoroethylene homopolymer) or polyhexafluoropropylene, with polytetrafluoroethylene being preferred.

Typically, the perfluoropolyalkylene, such as the PTFE, has a molecular weight of about 25,000 to about 2,500,000, preferably about 30,000 to about 100,000, most preferably about 30,000 to about 75,000. Useful commercially available PTFE suspensions contain PTFE having a molecular weight of about 40,000 to 45,000. If the composition is present in the form of a suspension the perfluoropolyalkylene, such as the PTFE, has a particle size of about 0.5 μm or less, preferably about 0.3 μm or less, most preferably about 0.2 μm or less.

The composition of the invention may comprise about 0.1 to about 10% by weight, preferably about 0.1 to about 6% by weight, most preferably about 0.2 to about 4% by weight of the perfluoropolyalkylene compound, such as PTFE, based on the total weight of the composition. A composition comprising from about 0.5 to about 4.0% by weight, preferably from 0.5 to 2.0% by weight of the perfluoropolyalkylene compound such as the polytetrafluoropolyethylene, based on the total weight of the composition has proven to provide for excellent results while using not too much of the perfluorocarbon.

Furthermore, the composition of the invention may contain up to about 20% by weight, preferably about 0.5 to about 16% by weight, most preferably about 1 to about 8% by weight of water, based on the total weight of the composition. In one embodiment the composition is free of any water.

The composition of the invention may further contain surfactants, i.e., wetting agents. This may in particular be necessary if the amount of water in the composition is high. The amount of surfactant employed may be varied and may be from about 0.001 to about 2% by weight, based on the weight of the composition. Typical surfactants are selected from non-ionic surfactants such as, for instance, alkylphenylpolyalkylene ether alcohols such as Triton X-100 and Triton X-114 from Union Carbide, Ipegal CO-610 from Rhone-Poulenc and Tergitol 12P12 from Union Carbide Company. A typical example is represented by dodecylphenylpolyethylene ether alcohol containing 12 ethylene oxide groups. Said non-ionic surfactants are characterized in terms of their HLB (hydrophile-lipophile balance) number. For simple alcohol ethoxylates, the HLB number may be calculated from HLB=E/5 wherein E represents the weight percentage of ethylene oxide in the molecule. Essentially, any wetting agent with a Hydrophile-Lipophile Balance number of from about 12.4 to about 18, preferably from about 13.5 to about 18.0, can be utilized.

An exemplary composition of the invention comprises methanol, ethanol, or a mixture thereof, from about 0.1 to about 10% by weight, preferably about 0.1 to about 4% by weight, most preferably about 0.5 to about 2% by weight of tetrafluoropolyethylene, based on the total weight of the composition, up to about 20% by weight, preferably about 0.5 to about 16% by weight, most preferably about 1 to about 8% or 4% by weight of water, based on the total weight of the composition. More preferred is a composition comprising, as the organic medium, a mixture of ethanol and iso-propanol containing about 50 to 90% by weight, more preferably about 70 to 90% by weight of ethanol, based on the alcohol mixture, 0.2 to 4% by weight of tetrafluoropolyethylene, based on the total weight of the composition and from about 1 to about 5% by weight of water, based on the total weight of the composition.

The composition of the present invention can be prepared by adding to the organic medium as described above the perfluoropolyalkylene such as polytetrafluoroethylene or an aqueous dispersion thereof. For instance, a particular polytetrafluoroethylene material is Krytox® LW-1200 or, alike, an aqueous PTFE dispersion sold under the trade designation DuPont DryFilm LW-1200, both available from DuPont. Both materials can be used interchangeably. Both materials represent non-flammable and stable dry lubricants that consist of small particles that yield stable dispersions. They are furnished as an aqueous dispersion of about 20+/−1 weight % solids by weight, pH 9 to 10, with a particle size of less than about 0.2 μm. The dispersion may include about 5% or more of a non-ionic surfactant. The small particle size facilitates spraying. The surfactant facilitates suspension of small particles and avoids agglomerates in aqueous medium. The polytetrafluoroethylene polymer melts at a temperature of from 323° C. to 328° C., preferably at about 323° C. to 325° C. It has a molecular weight of about 40,000 (DryFilm LW-1200) to 45,000 (Krytox® LW-1200). It has a reversible heat of fusion of 50 to 65 Joules/g. The PTFE from both Krytox® LW-1200 and Dry Film LW-1200 can be melt-coated onto a surface by heating the coated surface to a temperature of 340-360° C. for about 5 to 10 minutes.

Thus, by adding, for instance, 50 g, 100 g, or 200 g of said aqueous suspension that contains about 20 wt.-% PTFE to the organic medium in an amount to add up to 1,000 g there is obtained a composition containing 1%, 2%, or 4% by weight of PTFE, said composition containing 4%, 8%, or 16% by weight of water, respectively.

It has surprisingly been found that the suspensions obtained such as the PTFE suspensions are stable over a long time without additional homogenization and that they are sprayable using the conventional spraying equipment.

The method of making a razor blade according to the invention comprises providing a substrate with a cutting edge defined by a sharpened tip and adjacent facets, and applying the composition as described above over said sharpened tip to result in an outer coating layer. The composition may be applied to the substrate surface by spraying, dipping, or brushing. As will be explained herein below the substrate may be represented by a core made, for instance, of steal, which may optionally be coated with one or more coating layers to the outer layer of which the coating composition according to the invention is applied.

After the applying the coating that still contains the organic medium and, the optional low amount of water, the coating can be air dried or melt coated. The drying is facilitated and proceeds smoothly due to the low amount of water present, or the essential absence of water. The organic solvent is easily evaporated at lower temperatures. If necessary, the substrate, i.e. the razor blade or stack or coil of razor blades to be coated can be heated. For the purpose of this invention the substrate may be kept at a temperature of from about 35° C. to 70° C., preferably 45° C. to 60° C., i.e. lower than the temperature typically employed for water-based perfluorocarbon coating compositions.

In a typical procedure the composition of the invention is sprayed onto the exposed edges (facet regions) of the substrate, typically of a stack or coil of preheated blades that are simultaneously coated. The stack or coil is then placed in an oven to raise the temperature above the melting temperature of the perfluorocarbon, i.e., 325° C. to 329° C. for tetrafluoropolyethylene, to melt and uniformly spread the perfluorocarbon material. Typically, the heating is carried out in an inert atmosphere of nitrogen or argon, or a reducing atmosphere comprising nitrogen and hydrogen.

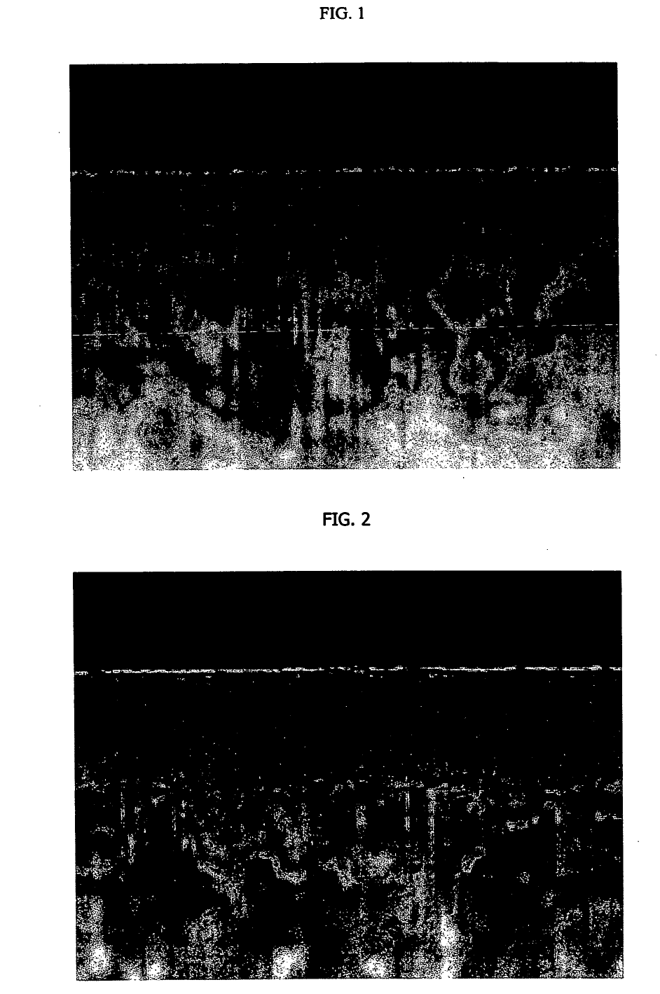

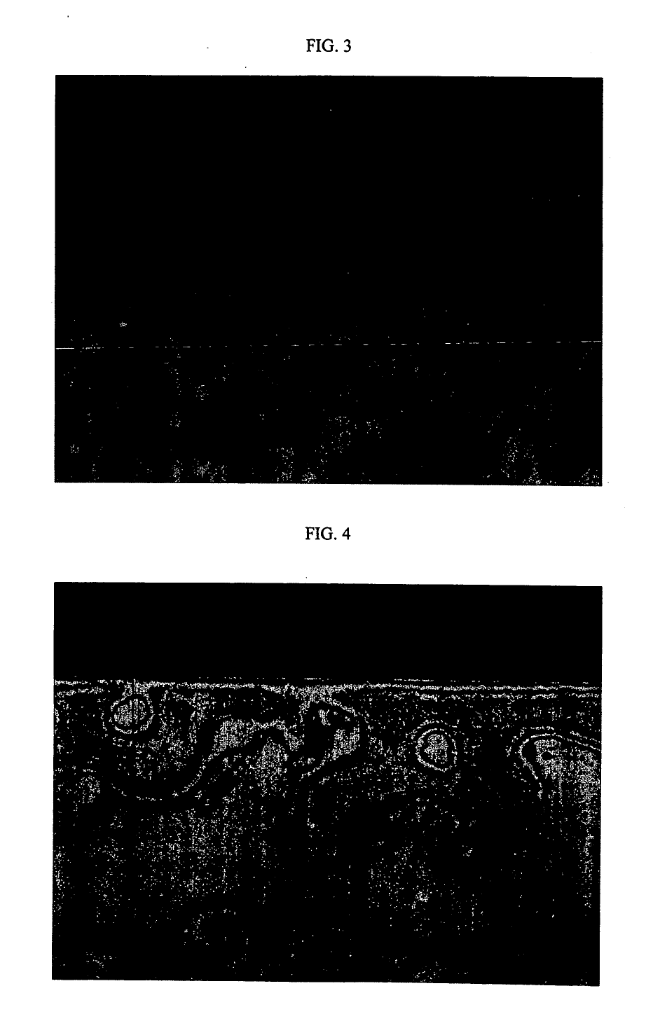

The method of this invention yields an outer coating layer having a thickness of less than about 500 nm, preferably between about 10 nm and about 400 nm, most preferably between about 100 and 400 nm. By an examination of the coated surface it was found that it is smoother and more uniform compared to a coating that is made by the prior art method using the aqueous PTFE dispersion. Reference is made to FIGS. 1 to 4. Without wanting to be bound by any theory or mechanism it is assumed that the reason for this effect is the surface tension of the water which leads to uncontrolled boiling retardations on the hot substrate surface (that typically occur in a temperature range of about 80 to 130° C. if an aqueous suspension is used) which, in turn, give raise to an irregular surface polymer coating. As a consequence of the method of the invention it has been found that the cut force of the inventive blade is significantly reduced and the lubricity is increased. The coefficient of friction when cutting is reduced further.

A typical razor blade according to the invention includes a substrate that is preferably made of stainless steel and has an ultimate edge sharpened to a tip radius of less than 100 nm, preferably 20 nm to 30 nm, and has a profile with side facets at an included angle of between 15 and 30 degrees, preferably about 19 degrees, measured at 40 μm from the tip. Other equivalent substrate materials may alternatively be used. The razor blade of the invention may also include at least one of a layer selected from an interlayer, a hard coating layer, an overcoat layer arranged between the substrate and the and outer layer that is formed from the composition of the present invention.

The interlayer may be used to facilitate bonding of the hard coating layer to the substrate. Examples of suitable interlayer materials niobium, chromium and titanium. Furthermore nitrides or carbides of these metals such as chromium nitride, titanium nitride or titanium carbide can be used. A particular interlayer is made of niobium greater than about 10 nm and preferably less than 50 nm thick. For instance, published international patent application WO 92/03330, the disclosure of which is incorporated herein by reference, describes the use of a niobium interlayer.

The hard coating layer provides improved strength, corrosion resistance and shaving ability and can be made from carbon containing materials (such as, for instance, diamond, amorphous diamond or a diamond like coating (DLC)), nitrides (such as, for instance, boron nitride, niobium nitride or titanium nitride), carbides (such as, for instance, silicon carbide or titanium carbide), oxides (such as, for instance, alumina, zirconia), or other ceramic materials. The carbon containing materials can be doped with other elements, such as tungsten, titanium or chromium by including these additives, for example in the target during application by sputtering. The materials can also incorporate hydrogen, such as hydrogenated DLC. Preferably the hard coating layer is made of diamond, amorphous diamond or DLC. A particular embodiment includes DLC less than 200 nm, preferably less than 100 nm. DLC layers and methods of deposition are described in U.S. Pat. Nos. 5,232,568 and 5,142,785 the disclosures of which are incorporated herein by reference. As described in the “Handbook of Physical Vapor Deposition (PVD) Processing” DLC is an amorphous carbon material that exhibits many of the desirable properties of diamond but does not have the crystalline structure of diamond. Further methods of applying diamond coatings and amorphous diamond coatings on the tip of a blade are disclosed in European published application EP 1440775 and the prior art references cited therein, all of which are incorporated herein by reference.

The overcoat layer may be used to reduce the tip rounding of the hard coated edge and to facilitate bonding of the outer layer to the hard coating while still maintaining the benefits of both. The overcoat layer is preferably made of chromium containing material, such as chromium or chromium alloys that are compatible with the perfluoropolyalkylenes such as the polytetrafluoroethylene, for instance, CrPt. A particular overcoat layer is chromium at a thickness of about 10 nm to 20 nm.

The razor blade is made generally according to the processes described in the above referenced patents, such as, for instance, U.S. Pat. No. 5,669,144,. A particular embodiment includes a niobium interlayer, DLC hard coating layer, chromium overcoat layer, and the outer coating layer of perfluoropolyalkylene, for instance, the polytetrafluoroethylene outer coat layer. Chromium overcoat layer is deposited to a minimum of 10 nm and a maximum of 50 nm. It is deposited by sputtering using a DC bias (more negative than minus 20 or minus 50 volts and preferably more negative than minus 200 volts) and pressure of about 0.267 Pa (2 millitorr) argon. The increased negative bias is believed to promote a compressive stress (as opposed to a tensile stress), in the chromium overcoat layer which is believed to promote improved resistance to tip rounding while maintaining good shaving performance. The blade according to the invention preferably has a tip radius of about 20 nm to about 40 nm, measured by SEM after application of overcoat layer and before adding outer polymer coating layer.

The razor blade can be used in shaving razors which typically include a handle and a replaceable shaving cartridge. Said cartridge includes a housing which carries between two and four, typically three or four blades, a guard and a cap. A typical view of such razors is apparent from the above mentioned patents and patent applications and, such as U.S. Pat. No. 6,684,513 the disclosure of which is fully incorporated herein by reference. The blades are movably mounted, as described, e.g., in U.S. Pat. No. 5,918,369, which is incorporated by reference. The cartridge also includes interconnect member on which housing is pivotally mounted at two arms. The interconnect member may include a base which is replaceably connected to the handle. Alternatively, the blade can be used in other razors having one, two to four blades, double-sided blades, and razors that do not have movable blades or pivoting heads where the cartridge is either replaceable or permanently attached to a razor handle.

In use, the razor blade according to the present invention exhibits shaving characteristics that are improved which respect to cut forces necessary and lubricity. The perfluoropolyalkylene outer coating, for instance, the polytetrafluoroethylene coating applied according to the process of the invention provides for a reduced coefficient of friction when cutting.

The present invention is further described in detail with reference to examples. However, the scope of the present invention is not restricted to the examples described hereunder.

### EXAMPLES

Coating Compositions

a) 80 g of an aqueous about 20 wt.-% dispersion of polytetrafluoroethylene particles (having a particle size of less than about 0.1 μm) commercially available from DuPont under the trade name Krytox® LW-1200 or Dry Film LW-1200 were added to 1,520 g of a mixture of ethanol with iso-propanol (at a weight ratio of ethanol to iso-propanol of about 4 to 1) while stirring. The resulting dispersion of the invention is stable and contains about 1% by weight of the PTFE polymer particles and about 3.75% by weight of water. By varying the amounts of PTFE dispersion to alcohol mixture dispersions containing 2% and 4% by weight PTFE particles (and 7.5% and 11.25% by weight of water, respectively) were similarly prepared and used in this experiments.

b) An aqueous 1% by weight PTFE particles containing dispersion was prepared by diluting Krytox® LW-1200 with the amount of water. The water used was purified by reverse osmosis. The resultant dispersion was used for the comparative experiment. Using the dispersions described above conventional razor blade (coils) were coated. The outer layer of the razor blade substrates was an amorphous diamond layer having a thickness of about 300 μm. The coating of the exposed edges (facet regions) of the blades was conducted using a conventional spraying apparatus. The razor blades were pre-heated to 60° C. (alcoholic coating composition) and 110° C. (aqueous coating composition). After the coating the coils of blades were placed in an oven and they were kept there under an inert atmosphere of dry nitrogen/hydrogen at a temperature of 340° C. to 350° C. for 12 minutes. Thereafter the blades were removed from the oven and they were allowed to cool.

Cut forces are measured using a measuring rig that is able to record and analyze the force that is required to move a razor blade a defined depth (cutting depth) at a defined speed (cutting speed) into a substrate. The following 4 elements are part of the instrument:

1. A fixture that holds the razor blade unit.

2. The fixture is mounted onto an arm that can be moved up and down, which is controlled by a servo-motor that allows the movement of the blade at an exactly defined speed and a defined way perpendicular to the surface of the cutting substrate into the medium.

3. The cutting substrate needs to be made of a defined and highly reproducible material to eliminate substrate effects as far as possible. It has been found, that chromatographic paper is a suitable medium that fulfils the requirements in an appropriate manner.

4. The fixture on the moveable arm is connected to a load cell that allows to record the forces required to move the blade edge into the substrate. The load cell is connected to a computer that is programmed to transfer the generated data into a specific format that allows the analysis of the data.

5. In this specific experiment the razor blade to be tested was moved into a chromatographic paper (Grade 17 CHROMA, size 220×25 mm; from Whatman plc, Great Britain) that was perfectly perpendicularly mounted to the razor blade. The cutting speed was 15 mm/min.

Multiple cuts are done into the substrate. The representative force of each cutis stored by the computer and then a regression analysis is carried out. As result of the regression, two mathematically depending values are received: intercept and slope. The intercept value can be correlated to the sharpness of the blade, while the slope gives information of the consistency of the blade. Consistency is meaning in the case of cut force testing both Blade-edge stability and PTFE adhesion. In addition, the cut force level after bulk PTFE removal is analyzed. For a razor blade it is desired to have a sharp and stable blade, which means for the PTFE good coverage and no adhesion issues. Thus said, it is desired to have a low intercept resp. a low cut force level, and a zero to negative slope (depending on the number of cuts and the associated data analysis technique).

Lubricity is measured using a measuring rig that is able to record and analyse the force that is required to move a razor blade under a well defined contact angle under a controlled constant load over a test medium. It has to be ensured that only the ground and PTFE coated facets (mainly the area of the first and final hone angle of 10°) are in contact with the medium. The movement of the sled (390 g, 83 mm×54 mm×28 mm stainless steel surface) is conducted at a defined speed (20 mm/sec) into a substrate (Whatman Paper Grade 54 SFC; 3.81 cm×91.44 m).

The instrument contains in principle of 3 parts:

1. A fixture (sled) that holds the razor blade unit and creates the constant load.

2. The fixture is in contact with a load cell. The substrate is moved underneath the contacting blade edge almost parallel to the contacting portion of the facet. The load cell is connected to a computer that is programmed to transfer the generated data into a specific format that allows the analysis of the data.

3. The substrate needs to be made of a defined and highly reproducible material to eliminate substrate effects as far as possible. It has been found, that chromatographic paper is a suitable medium that fulfils the requirements in an appropriate manner.

Generally, lubricity testing delivers the following values:

Start Force: Measures begin of cohesion-driven delamination of polymer

Peak Force: Maximum Force of trace; measures adhesion and cohesion of bulk Polymer

Levelling Force: Force Level when a steady-state is reached (sliding friction of polymer)

End Force: Force Level after defined travel distance

Rise Force: Difference between End Force and Levelling Force; Should be smaller or equal to ZERO ensure proper PTFE (Monolayer) adhesion

Typically, special attention is given the two values “level”, which describes the frictional properties of the polymer and “Rise” which is the measure of the adhesion of the polymer of the substrate.

The optical inspection of the coated razor blade tip surface was conducted using a conventional light microscope at a magnification of 200 to 500. If desired, the light source may be changed to use polarized light which enhances the contrast between areas of different coating thickness. The results obtained by using the coating methodology according to the invention in comparison to a PTFE coating process involving an aqueous PTFE dispersion is shown in FIGS. 1 to 3 and 4, respectively.

The following Table summarizes the physical characteristics of edges sprayed with suspensions of the LW-1200 alcohol based media (in various concentrations) and LW-1200 water based media:

TABLE

| | Alcoholic | | Alcoholic | | Alcoholic | | Aqueous | |
|---|---|---|---|---|---|---|---|---|
| | Dispersion | | Dispersion | | Dispersion | | Dispersion | |
| | 0.5% b.w. PTFE | | 1% b.w. PTFE | | 2% b.w. PTFE | | 2% b.w. PTFE | |
| | (Invention) | | (Invention) | | (Invention) | | (Comparative) | |
| Polymer | PTFE LW-1200 ¹⁾ | | PTFE LW-1200 ¹⁾ | | PTFE LW-1200 ¹⁾ | | PTFE LW-1200 ¹⁾ | |
| Molecular Weight | 40,000 | | 40,000 | | 40,000 | | 40,000 | |
| Particle Size | <0.1 | μm | <0.1 | μm | <0.1 | μm | <0.1 | μm |
| Melting Point | 323° | C. | 323° | C. | 323° | C. | 323° | C. |
| Blade Temperature | 60° | C. | 60° | C. | 60° | C. | 110° | C. |
| Sintering Temperature | 340-350° | C. | 340-350° | C. | 340-350° | C. | 340-350° | C. |
| Sintering Time | 12 | min | 12 | min | 12 | min | 12 | min |
| Cut Force | | | | | | | | |
| Intercept ²⁾ | 10.3 | N | 10.5 | N | 11.1 | N | 10.5 | N |
| Slope ²⁾ | −0.08 | N/cut | −0.15 | N/cut | −0.15 | N/cut | −0.02 | N/cut |
| Level ³⁾ | 10.0 | N | 9.7 | N | 9.9 | N | 10.3 | N |
| Rise ³⁾ | 0.0 | N/cut | 0.0 | N/cut | 0.0 | N/cut | 0.02 | N/cut |

| | | | | |
|---|---|---|---|---|
| Lubricity | | | | |
| Level | 26.5 | 26.5 | 26.5 | 27.0 |
| Rise | −0.5 | −1.0 | −1.0 | 0.5 |
| PTFE Visual | + | + | + | − |
| Appearance ³⁾ | | | | |
| Pictures Light | | | | |
| Microscope 200× | | | | |
| Comments ⁴⁾ | Coverage ok, | Target | Coverage ok, | Out of spec, tip |
| | lower spec limit | Coverage | upper spec limit | not covered (voids) |

¹⁾ based on Krytox ® LW-1200/DryFilm LW-1200, DuPont, USA
²⁾ based on linear regression C2→ C6
³⁾ based on 60 chop cut force testing
⁴⁾ rating by optical inspection:
+: = uniform, smooth, no surface deflect/flaws
−: = surface having a considerable number of defects

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A composition comprising:
(i) a perfluoropolyalkylene compound, and
(ii) an organic liquid medium having a boiling point of about 100° C. or less.

2. The composition of claim 1 in the form of a suspension.

3. The composition of claim 1, wherein the perfluoropolyalkylene is selected from the group of perfluoropoly(C₂-C₄)alkylenes.

4. The composition of claim 3, wherein the perfluoropolyalkylene is selected from the group consisting of polytetrafluoroethylene or polyhexafluoropropylene.

5. The composition of claim 1, wherein the organic medium is selected from the group consisting of C₂-C₄ aldehydes, C₃-C₄ ketones, C₁-C₃ alcohols, and mixtures thereof.

6. The composition of claim 5, wherein the organic medium is selected from the group consisting of acetaldehyde, propionaldehyde, butane aldehyde, acetone, methylethyl ketone, methanol, ethanol, propanol, iso-propanol, sec.-butanol, tert.-butanol, and mixtures thereof

7. The composition of claim 6, wherein the organic medium comprises an alcohol mixture of ethanol and iso-propanol containing about 10 to about 95% by weight, preferably about 30 to about 90% by weight, most preferably about 60 to about 90% by weight of ethanol, based on said alcohol mixture.

8. The composition of claim 1 comprising about 0.1 to about 10% by weight, preferably about 0.1 to about 6% by weight, most preferably about 0.2 to about 4% by weight of the perfluoropolyalkylene compound, based on the total weight of the composition.

9. The composition of claim 1 containing up to about 20% by weight, preferably about 0.5 to about 16% by weight, most preferably about 1 to about 8% by weight of water, based on the total weight of the composition.

10. The composition of claim 1, wherein the perfluoropolyalkylene has a molecular weight of about 25,000 to about 2,500,000, preferably about 30,000 to about 100,000, most preferably about 30,000 to about 60,000.

11. The composition of claim 1, wherein the perfluoropolyalkylene has a particle size of about 0.5 μm or less, preferably about 0.3 μm or less, most preferably about 0.2 μm or less.

12. The composition of claim 1 comprising:
an organic liquid medium selected from the group consisting of methanol, ethanol, or a mixture thereof,
from about 0.1 to about 10% by weight, preferably about 0.1 to about 5% by weight, most preferably about 0.2 to about 2% by weight of tetrafluoropolyethylene, based on the total weight of the composition,
up to about 20% by weight, preferably about 0.5 to about 16% by weight, most preferably about 1 to about 8% by weight of water, based on the total weight of the composition.

13. The composition of claim 12, wherein the organic liquid medium is an ethanol/iso-propanol mixture comprising about 50 to 90% by weight of ethanol, based on said alcohol mixture.

14. A method of making a razor blade comprising:
providing a substrate with a cutting edge defined by a sharpened tip and adjacent facets, and applying the composition as defined in claim 1 over said sharpened tip to result in an outer coating layer.

15. The method of claim 14, wherein the composition is applied to the surface of said sharpened tip by spraying, dipping, or brushing.

16. The method of claim 14 further comprising: the step of air-drying or melting the outer coating layer.

17. The method of claim 16, wherein the step of drying the outer coating layer is conducted at a temperature above the melting temperature of the perfluoropolyalkylene.

18. The method of claim 16, wherein the step of air-drying or melting the outer coating layer is conducted under an inert atmosphere of nitrogen, argon or nitrogen/hydrogen.

19. The method of claim 14, wherein the thickness of the outer coating layer is less than about 500 nm, preferably between about 10 nm and about 400 nm, most preferably between about 100 and 400 nm.

20. The method of claim 14, wherein a plurality of razor blades arranged in the form of a stack is simultaneously coated.

21. A razor blade comprising:
a substrate with a cutting edge defined by a sharpened tip and adjacent facets, and
an outer coating layer,
wherein said razor blade is obtainable by the method as defined in claim 14.

22. The razor blade of claim 21 comprising at least one of
an interlayer,
a hard coating layer, and
an overcoat layer,
wherein said layer or layers is/are arranged between the substrate and the outer coating layer.

23. The razor blade of claim 21, wherein the thickness of the outer coating layer is less than about 500 nm, preferably between about 10 nm and about 400 nm, most preferably between about 100 and about 400 nm.

24. The razor blade of claim 22, wherein the interlayer comprises niobium, chromium, titanium or nitrides or carbides of these metals.

25. The razor blade of claim 22, wherein the hard coating layer comprises diamond or a diamond-like material.

26. The razor blade of claim 22, wherein the overcoat layer consists of a chromium containing alloy.

27. The razor blade of claim 22, wherein the order of the layers on the substrate is the interlayer, the hard coating layer, the overcoat layer, and the outer coating layer.

28. A shaving razor comprising a handle, a housing and at least one razor blade a defined in claim 21 mounted in said housing.

29. The shaving razor of claim 28, wherein said housing contains from 2 to 4 razor blades.
